(19) United States
(12) Patent Application Publication
(10) Pub. No.: US 2025/0133170 A1
(43) Pub. Date: Apr. 24, 2025

(54) IMAGE PROCESSING APPARATUS, CONTROL METHOD, AND CONTROL PROGRAM

(71) Applicant: KYOCERA CORPORATION, Kyoto-shi (JP)

(72) Inventors: Hiroshi OKA, Kyoto-fu (JP); Shingo ITO, Nagoya-shi (JP); Daisuke HARA, Kusatsu-shi (JP)

(21) Appl. No.: 19/002,706

(22) Filed: Dec. 27, 2024

Related U.S. Application Data
(63) Continuation of application No. PCT/JP2022/026027, filed on Jun. 29, 2022.

(51) Int. Cl. H04N 1/00

(52) U.S. Cl. CPC H04N 1/00416; H04N 1/00474; H04N 1/00506; H04N 1/00514; H04N 2201/0094

(57) ABSTRACT

An image processing apparatus includes an operation panel including a display that displays, in juxtaposition, a menu region with function buttons each corresponding to a type of image processing operation are arranged and a history region with history buttons each corresponding to a completed image processing operation are arranged, and an operator that receives an operation on each of the buttons arranged in the menu region and the history region. In the history region, an individual history button that displays information on the completed image processing operation individually per image processing operation and a group history button that displays a group obtained by classifying the completed image processing operation according to a classification condition are arranged in juxtaposition. The display displays, in the history region, classification information that is information indicating the classification condition and that is associated with the group history button.

### RELATED APPLICATIONS

The present application is a continuation based on PCT Application No. PCT/JP2022/026027, filed on Jun. 29, 2022. The content of which is incorporated by reference herein in their entirety.

### TECHNICAL FIELD

Present disclosure relates to an image processing apparatus, a control method, and a control program.

### BACKGROUND

Patent Document 1 discloses an image processing apparatus including an operation panel that displays, in juxtaposition, a menu region in which function buttons corresponding to types of image processing are arranged and a history region in which history buttons corresponding to image processing completed in the past (hereinafter referred to as “completed image processing”) are arranged. In such an image processing apparatus, setting contents for the image processing corresponding to the history button are reproduced in response to the reception of the operation of selecting the history button, and thus the time and effort can be saved that are required for the user to input the setting contents.

### CITATION LIST

### Patent Literature

Patent Document 1: JP 2020-43495 A

### SUMMARY

The image processing apparatus as described above has room for improvement in terms of further enhancing convenience for a user who uses the history button.

The present disclosure provides an image processing apparatus, a control method, and a control program that are capable of further improving convenience for a user.

In a first aspect of the present disclosure, an image processing apparatus includes an operation panel including a display that displays, in juxtaposition, a menu region in which a plurality of function buttons each corresponding to a type of image processing operation are arranged and a history region in which a plurality of history buttons each corresponding to a completed image processing operation are arranged, and an operator that receives an operation on each of the plurality of function buttons arranged in the menu region and the plurality of history buttons arranged in the history region. In the history region, an individual history button that displays information on the completed image processing operation individually per image processing operation and a group history button that displays a group obtained by classifying the completed image processing operation according to a classification condition are arranged in juxtaposition. The display displays, in the history region, classification information that is information indicating the classification condition and that is associated with the group history button.

In a second aspect of the present disclosure, a control method is a method for controlling an image processing apparatus. The control method includes displaying, in juxtaposition on an operation panel, a menu region in which a plurality of function buttons each corresponding to a type of image processing operation are arranged and a history region in which a plurality of history buttons each corresponding to a completed image processing operation are arranged, and receiving, on the operation panel, an operation on each of the plurality of function buttons arranged in the menu region and the plurality of history buttons arranged in the history region. In the history region, an individual history button that displays information on the completed image processing operation individually per image processing operation and a group history button that displays a group obtained by classifying the completed image processing operation according to a classification condition are arranged in juxtaposition. The displaying includes displaying, in the history region, classification information that is information indicating the classification condition and that is associated with the group history button.

In a third aspect of the present disclosure, a control program causes an image processing apparatus to execute displaying, in juxtaposition on an operation panel, a menu region in which a plurality of function buttons each corresponding to a type of image processing operation are arranged and a history region in which a plurality of history buttons each corresponding to a completed image processing operation are arranged, and receiving, on the operation panel, an operation on each of the plurality of function buttons arranged in the menu region and the plurality of history buttons arranged in the history region. In the history region, an individual history button that displays information on the completed image processing operation individually per image processing operation and a group history button that displays a group obtained by classifying the completed image processing operation according to a classification condition are arranged in juxtaposition. The displaying includes displaying, in the history region, classification information that is information indicating the classification condition and that is associated with the group history button.

### BRIEF DESCRIPTION OF THE DRAWINGS

FIG. 1 is a diagram illustrating a functional block configuration of an image processing apparatus according to an embodiment.

FIG. 2 is a diagram illustrating an outer appearance configuration example of the image processing apparatus according to the embodiment.

FIG. 3 is a diagram illustrating an example of a home screen displayed in a display of an operation panel according to the embodiment.

FIG. 4 is a diagram illustrating an example of a copy screen according to the embodiment.

FIG. 5 is a diagram illustrating an example of screen display provided when a history region (history button) according to the embodiment is operated.

FIG. 6 is a diagram for describing group history buttons according to the embodiment.

FIG. 7 is a diagram illustrating an example of screen display provided when a group history button according to the embodiment is tapped.

FIG. 8 is a diagram illustrating another example of screen display provided when the group history button according to the embodiment is tapped.

FIG. 9 is a diagram illustrating another example of screen display provided when the group history button according to the embodiment is tapped.

FIG. 10 is a diagram illustrating a control flow for the image processing apparatus according to the embodiment.

FIG. 11 is a diagram for describing a first variation related to the group history buttons according to the embodiment.

FIG. 12 is a diagram for describing a second variation related to the group history buttons according to the embodiment.

FIG. 13 is a diagram for describing the second variation related to the group history buttons according to the embodiment.

FIG. 14 is a diagram for describing a third variation related to the group history buttons according to the embodiment.

FIG. 15 is a diagram for describing the third variation related to the group history buttons according to the embodiment.

FIG. 16 is a diagram for describing a fourth variation related to the group history buttons according to the embodiment.

FIGS. 17A and 17B are diagrams for describing a fifth variation related to the group history buttons according to the embodiment.

FIG. 18 is a diagram for describing a sixth variation related to the group history buttons according to the embodiment.

FIG. 19 is a diagram for describing the sixth variation related to the group history buttons according to the embodiment.

FIG. 20 is a diagram for describing the sixth variation related to the group history buttons according to the embodiment.

### DESCRIPTION OF EMBODIMENTS

An image processing apparatus according to an embodiment will be described with reference to the drawings. In the description of the drawings, the same or similar parts are denoted by the same or similar reference signs.

### Configuration of Image Processing Apparatus

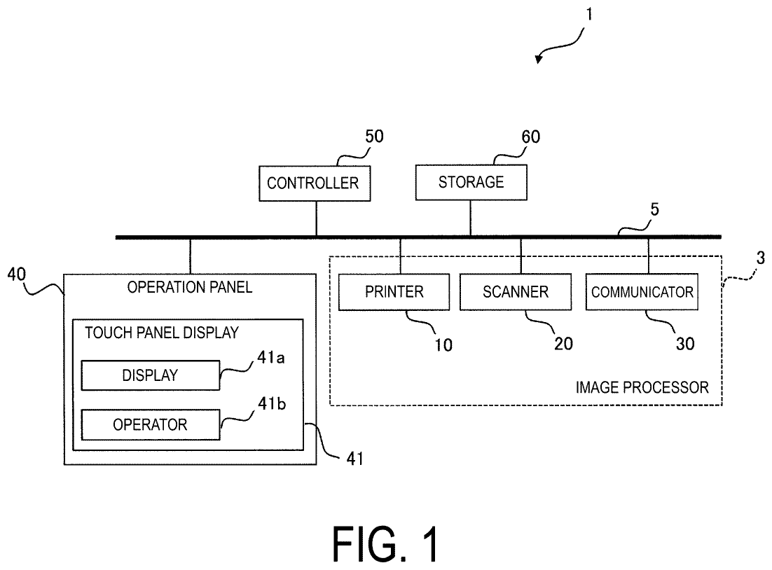

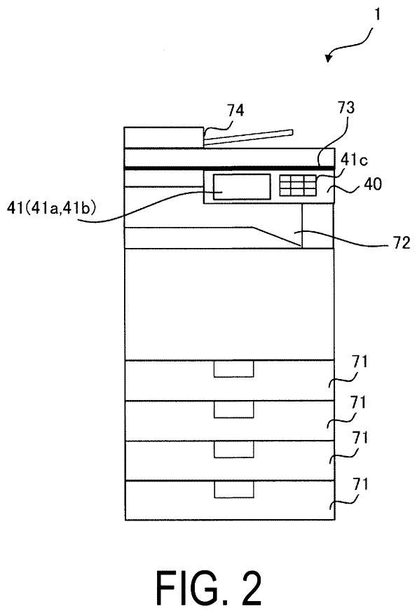

FIG. 1 is a diagram illustrating a functional block configuration of an image processing apparatus 1 according to an embodiment. FIG. 2 is a diagram illustrating an outer appearance configuration example of the image processing apparatus 1 according to the embodiment. Note that the “image” may include only characters. A format of the “image data” may be various, and may be, for example, a vector format or a raster format. In the description of the present embodiment, “image” and “image data” may not be strictly distinguished from each other for the sake of convenience. The “image data” may be converted into an appropriate format in the course of the image processing.

As illustrated in FIG. 1, the image processing apparatus 1 includes a printer 10, a scanner 20, a communicator 30, an operation panel 40, a controller 50, and a storage 60. The image processing apparatus 1 has a configuration capable of performing one or more types of image processing. The embodiment is provided with the printer 10, the scanner 20, and the communicator 30, as a configuration for performing image processing. The printer 10, the scanner 20, and the communicator 30 constitute an image processor 3. However, the image processing apparatus 1 may include only one of the printer 10 and the scanner 20, or may not need to include the communicator 30.

In the present disclosure, types of image processing executed by the image processor 3 include “print”, “copy”, “scan”, and “facsimile (FAX)”. In other words, the image processing apparatus 1 has functions of “print”, “copy”, “scan”, and “FAX”. “Copy” is a function of using the printer 10 to print, on a sheet, an image scanned by the scanner 20. “Print” is a function of using the printer 10 to print an image based on data received by the communicator 30 from the outside or an image based on data stored in a recording medium (not illustrated) connected to the image processing apparatus 1. “Scan” is a function of storing an image scanned by the scanner 20 as data. For example, a storage destination is an auxiliary storage apparatus (a non-volatile memory from another viewpoint) included in the storage 60, a storage medium connected to the image processing apparatus 1, or another device that performs communication with the image processing apparatus 1 via the communicator 30. “FAX” refers to a function in which the printer 10 prints, on a sheet, data received by the communicator 30 from the outside via a telephone line, and a function in which the communicator 30 transmits image data scanned by the scanner 20 to the outside via the telephone line.

The image processor 3 may not need to support all of these functions. The image processor 3 may support only one or only two of the functions of “print”, “copy”, “scan”, and “FAX”, for example. The image processor 3 may further support an “email” function. “Email” is a function of performing setting and/or execution related to email. With this function, for example, a part or all of contents of an email received by the communicator 30 may be printed by the printer 10, or data of an image scanned by the scanner 20 may be transmitted by the communicator 30 via email.

The printer 10 performs image printing under control of the controller 50. For example, the printer 10 performs printing on a sheet arranged on a sheet feed tray 71 illustrated in FIG. 2, and discharges a printed sheet to a sheet discharge tray 72. The printer 10 may include only one sheet feed tray 71 or may include a plurality of sheet feed trays 71. A plurality of sheet feed trays 71 can accommodate, for example, sheets of different sizes. From another viewpoint, the printer 10 may have a function of selecting a size of a sheet. The printer 10 may be configured to enable color (as well as monochrome and grayscale) printing.

The scanner 20 performs image scanning under control of the controller 50, and generates image data. Specifically, the scanner 20 images (scans) a document set on a document table 73 or an auto document feeder (ADF) 74 illustrated in FIG. 2 by an imaging device that moves along a document glass to generate image data.

The communicator 30 performs image data communication under control of the controller 50. Specifically, the communicator 30 realizes communication between the image processing apparatus 1 and another device. Examples of the other device include a personal computer (PC), a mobile terminal (such as a smartphone), another image processing apparatus, and a server. Examples of the server include a file server, a mail server, and a Web server. The communication may be directly performed with another device, or may be indirectly performed via a network. Examples of the network include a telephone network, the Internet, a private network, and a local area network (LAN). The communication may be wired communication or wireless communication.

The operation panel 40 constitutes an operator that receives a user operation (user input). The operation panel 40 includes a touch panel display 41. As illustrated in FIG. 2, the operation panel 40 may include one or more physical buttons 41c. The touch panel display 41 includes a display 41a that displays an image under control of the controller 50 and an operator 41b that receives a touch operation on the display 41a. For example, the display 41a includes a liquid crystal display or an organic electro luminescence (EL) display. These displays include a relatively large number of pixels regularly arranged, and can display an image including an arbitrary shape based on image data. The display 41a may be capable of displaying a color image. The operator 41b detects a position of a touch operation on the display 41a, and outputs detection results to the controller 50. The operator 41b may include a touch panel that overlaps the display 41a and an analog-to-digital (A/D) converter that performs analog-to-digital (A/D) conversion on an output of the touch panel. In the description of the embodiment, terms indicating specific modes such as “press”, “touch”, and “tap” may be used for “operation” on the operator 41b for the sake of simplicity, but these terms may be generalized as “predetermined operation”.

The controller 50 includes one or more processors, and controls the entire image processing apparatus 1. The controller 50 executes various types of processing operations by executing a control program stored in the storage 60. The controller 50 controls operations of the printer 10, the scanner 20, the communicator 30, and the operation panel 40. For example, upon receiving an operation (instruction) from the user via the operation panel 40, the controller 50 executes processing corresponding to operation details. The operation panel 40 displays various operation screens on the touch panel display 41 in accordance with instructions from the controller 50. Note that the controller 50 may include a logic circuit configured to perform only a certain operation.

For example, the storage 60 includes various memories such as a Read Only Memory (ROM), a Random Access Memory (RAM), and an auxiliary storage apparatus. Note that a combination of the controller 50 and the storage 60 may be considered as a computer. The program to be executed by the controller 50 is stored in the ROM and/or the auxiliary storage apparatus of the storage 60, for example. In the embodiment, the storage 60 stores, for each image processing operation completed by the image processor 3, history information in which the date and time when the image processing operation was executed, the type of the image processing operation, the setting contents in the image processing operation, and the name of the user who performed the image processing operation (hereinafter also referred to as “username corresponding to the image processing operation”) are associated with one another. The history information stored in the storage 60 is used for history display to be described later.

The printer 10, the scanner 20, the communicator 30, the operation panel 40, the controller 50, and the storage 60 are connected by a bus 5, for example. In FIG. 1, all of the components are schematically connected to one bus 5, but a plurality of buses may be present. For example, an address bus, a data bus, and a control bus may be provided.

Note that, as an outer appearance of the image processing apparatus 1, FIG. 2 illustrates an outer appearance of a multi-function printer for business use. However, the image processing apparatus 1 may be used in any manner. For example, the image processing apparatus 1 may be installed in a user's home and personally used, or may be installed in a company and used by a plurality of specific users, or may be installed in a store, such as a supermarket or a convenience store, and used by a plurality of unspecified users.

### Screen Display on Operation Panel

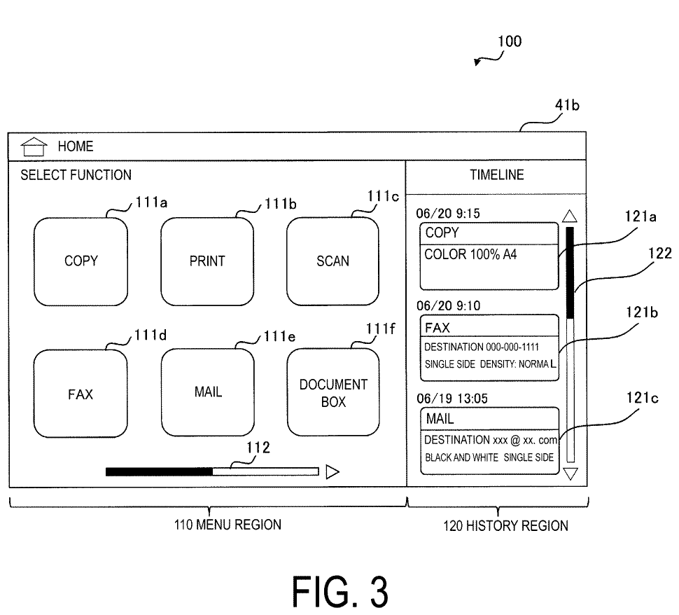

FIG. 3 is a diagram illustrating an example of a home screen 100 displayed on the display 41a of the operation panel 40 according to the embodiment. The home screen 100 is, for example, a screen displayed when the user starts using the image processing apparatus 1. From another point of view, the home screen 100 is a screen that is started up when the image processing apparatus 1 is powered on, when the image processing apparatus 1 returns from the sleep mode, and/or when user authentication is successful in the image processing apparatus 1.

As illustrated in FIG. 3, a menu region 110 and a history region 120 are displayed in juxtaposition on the home screen 100. In the embodiment, the menu region 110 and the history region 120 are configured by dividing the home screen 100 into two parts in the horizontal direction. Note that the menu region 110 may be referred to as a main display region. The history region 120 may be referred to as a timeline region.

In the menu region 110, a plurality of function buttons 111 (111a to 111f) corresponding to types of image processing operations are arranged. On the other hand, in the history region 120, a plurality of history buttons corresponding to completed image processing operations are arranged. Here, each history button displayed in the history region 120 is an individual history button 121 (121a to 121c) individually displaying information on a completed image processing operation for each image processing operation. That is, each individual history button 121 is associated with a completed image processing operation (specifically, a completed image processing job). Note that the information displayed on the button may be text or a symbol image. The button may not need to mimic a physical button. For example, a button may be indicated only by text and/or a symbol image and may not need to have a frame border surrounding the text and/or the symbol image. Further, from another point of view, the boundary between the region for receiving the user's operation and the surrounding region may need not to be represented by a frame border or a difference in color.

The menu region 110 includes a plurality of function buttons 111 (111a, 111b, . . . ) corresponding to types of image processing operations (in the example of FIG. 3, “copy”, “print”, “scan”, “FAX”, “mail”, and “document box”). The menu region 110 may be scrollable by a scroll bar 112. In the illustrated example, the scroll direction is the horizontal direction. However, the scroll direction may be the vertical direction.

The number of function buttons 111 and the types of functions corresponding to the function buttons 111 may be set as appropriate. Hereinafter, the function button 111 may be referred to by the text displayed in the function button 111. The same applies to the other buttons. In FIG. 3, a copy button 111a, a print button 111b, a scan button 111c, a FAX button 111d, a mail button 111e, and a document box button 111f are illustrated as the function buttons 111.

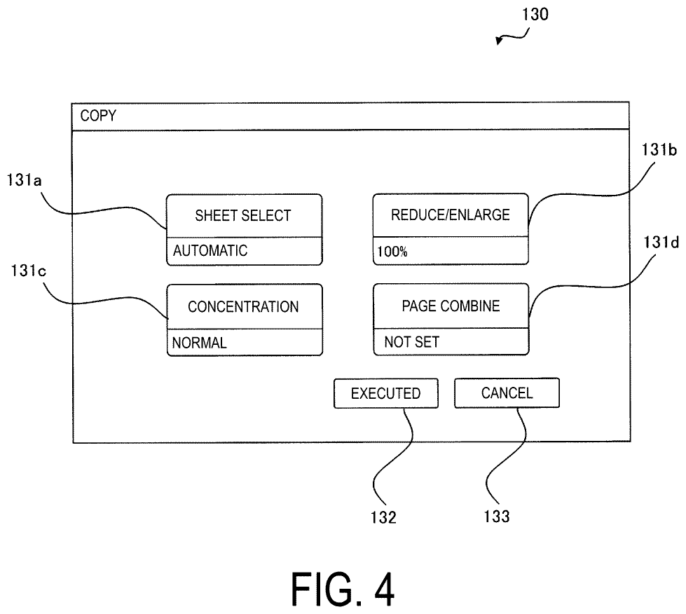

When any one of the function buttons 111 in the menu region 110 of the home screen 100 is tapped, the controller 50 controls the display 41a to switch the screen displayed on the display 41a to a screen for performing an operation related to the function corresponding to the function button 111. For example, when the copy button 111a is tapped, the controller 50 switches from the home screen 100 to a copy screen 130 illustrated in FIG. 4.

The copy screen 130 includes a plurality of setting buttons 131 (131a, 131b, . . . ) for setting conditions of image processing (here, copy conditions), an execution button 132 for instructing execution of copying, and a cancel button (return button from another viewpoint) 133 for returning to the home screen 100. The number and types of the setting buttons 131 are arbitrary. In the example of FIG. 4, the setting buttons 131 include a paper selection button 131a, an enlargement/reduction button 131b, a density button 131c, and a page combine button 131d. Since these are common buttons, description thereof will be omitted. The controller 50 sets copy conditions according to operations on the setting buttons 131. Then, when the execution button 132 is tapped, the controller 50 controls the image processor 3 to execute copying. When the button for returning to the home screen 100 is tapped or a certain period of time elapses, the controller 50 controls the display 41a to switch from the copy screen 130 to the home screen 100.

Unlike the above description, the controller 50 may control the image processor 3 to execute image processing (for example, copying) when the function button 111 is tapped. The conditions for the image processing (for example, the setting contents of copying) may be set on a dedicated screen for setting the processing conditions, the dedicated screen being displayed by tapping the dedicated function button 111 for setting the conditions.

On the other hand, the history region 120 illustrated in FIG. 3 is a display region indicating a history of image processing executed in the past. The position, shape, and area of the history region 120 are arbitrary. In the example of FIG. 3, the history region 120 is located on one side (right side in the illustrated example) in the horizontal direction on the home screen 100, having a rectangular shape with the horizontal direction defined as the longitudinal direction, the history region 120 having a rectangular shape with the vertical direction defined as the longitudinal direction. The width of the history region 120 is less than half or less than one-third of the width of the home screen 100. Note that most (for example, 80% or more) of the home screen 100 except for the history region 120 is the menu region 110. The history region 120 may be scrollable by a scroll bar 122. Although an example in which the scroll direction is the vertical direction is illustrated, the scroll direction may be the horizontal direction.

The maximum number of individual history buttons 121 that can be displayed by scrolling in the history region 120 is determined in advance. For example, in the history region 120, the individual history buttons 121 for up to the latest n jobs (n≥2) among the completed image processing jobs can be displayed by scrolling. In the example of FIG. 3, the number of individual history buttons 121 that can be displayed at a time in the history region 120 is three. However, the number of individual history buttons 121 that can be displayed at a time in the history region 120 may be two or four.

The plurality of individual history buttons 121 (121a, 121b, . . . ) are arranged in a line in a predetermined direction in the order of the date and time when the image processing corresponding to the individual history button 121 was executed (that is, in chronological order). The plurality of individual history buttons 121 may be arranged in any direction. The plurality of individual history buttons 121 may be arranged from one side to the other side in the arrangement direction (from the upper side to the lower side in the illustrated example) in reverse chronological order (in the illustrated example) or in chronological order, or may be switched between reverse chronological order and chronological order by performing a predetermined operation on the operation panel 40. Note that, in the description of the present embodiment, the individual history buttons 121 are assumed to be arranged in reverse chronological order for the sake of convenience. To be more specific, the individual history button 121a corresponding to the latest completed image processing (hereinafter also referred to as the “latest individual history button”) is arranged on the uppermost side, and the individual history button 121n corresponding to the oldest completed image processing (hereinafter also referred to as the “oldest individual history button”) is arranged on the lowermost side.

When image processing is executed via an operation on the function button 111 or an operation on the individual history button 121, the controller 50 adds a new individual history button 121 related to the image processing. When the image processing operation based on which the individual history button 121 is added is the same as the new image processing operation performed via the operation on the individual history button 121, the individual history button 121 may be newly added, or the execution date and time of the image processing operation corresponding to the operated individual history button 121 may be only updated (from another viewpoint, the display position of the individual history button 121 is changed). Here, the same image processing operations may mean, for example, that the image processing operations are the same except for the execution date and time. Note that, for image processing executed via an operation on the individual history button 121, unlike the description of the present embodiment, the individual history button 121 may not need to be added.

The type of image processing for which the individual history button 121 is generated is arbitrary. For example, even when the image processing apparatus 1 has the six functions illustrated in the menu region 110, the individual history button 121 need not be generated for all of the functions. For example, the individual history button 121 may be generated only for image processing operations in which printing is performed by the image processing apparatus 1, such as “copy” and “print” (and printing in “box”). For example, the individual history button 121 may be generated only for image processing operations in which scanning is performed by the image processing apparatus 1, such as “copy”, “scan”, “FAX”, and “mail”. For example, the individual history button 121 may be generated only for image processing operations in which communication is not performed, such as “copy”, “print”, and “scan” (and printing in “box”).

For image processing operations performed by transmitting a signal including a print job or the like from another device (for example, a PC) to the communicator 30, the individual history button 121 may or may not need to be added. When the individual history button 121 is added, reprinting can be performed via the individual history button 121, for example, when a user who has transmitted a print job from a PC to the image processing apparatus 1 confirms a failure in printing in front of the image processing apparatus 1.

As described above, the number of individual history buttons 121 (including those displayed by scrolling) that can be displayed in the history region 120 is limited to a predetermined upper limit value (n) or less. Therefore, when the number of individual history buttons 121 heretofore added reaches the upper limit value, further addition of a new individual history buttons 121 deletes the oldest individual history button 121. In other words, the oldest individual history button 121 cannot be displayed. Note that a specific value of the upper limit value (n) is arbitrary, and is, for example, 5, 10, or 20. The upper limit value may be set by the manufacturer of the image processing apparatus 1 and may be unchangeable by the administrator or the user of the image processing apparatus 1, or may be settable by the administrator of the image processing apparatus 1. In an aspect in which the display mode of the history region 120 can be varied for each user, the upper limit value may be settable by the user.

Each individual history button 121 includes (indicates) information on the corresponding image processing. Examples of the information include the date and time at which the image processing was executed, the type of the image processing, the condition (setting contents) of the image processing, and the name of the user who performed the image processing. Another example is a communication destination (a transmission destination and/or a reception destination) in the FAX function and/or the mail function. That is, each individual history button 121 indicates at least one piece of information among the type of completed image processing, the setting contents of the completed image processing, the processing date and time of the completed image processing, the username corresponding to the completed image processing, and the transmission destination in the completed image processing. Accordingly, the user can easily identify the corresponding completed image processing based on the information indicated by each individual history button 121.

Each individual history button 121 may display at least one or more of various pieces of information related to the image processing described above (for example, date and time, type, setting contents, and username). In an aspect in which the setting contents of the image processing are displayed in the individual history button 121, the specific setting contents to be displayed may be appropriately selected. In the individual history button 121a illustrated in FIG. 3, the specific setting contents include color (“color” or “black and white” is illustrated as an example), magnification (“100%” is illustrated as an example), and paper (“A4” or “automatic” is illustrated as an example).

The types of information on image processing included in the individual history buttons 121 (in other words, items displayed on the individual history buttons 121) may be the same or different among the individual history buttons 121. For example, the type of information displayed on the individual history button 121 may vary depending on the type of image processing. More specifically, the individual history button 121 in which the type of image processing is copy may not need to have an item displaying a communication destination, whereas the individual history button 121 in which the type of image processing is FAX or mail may have an item displaying a communication destination.

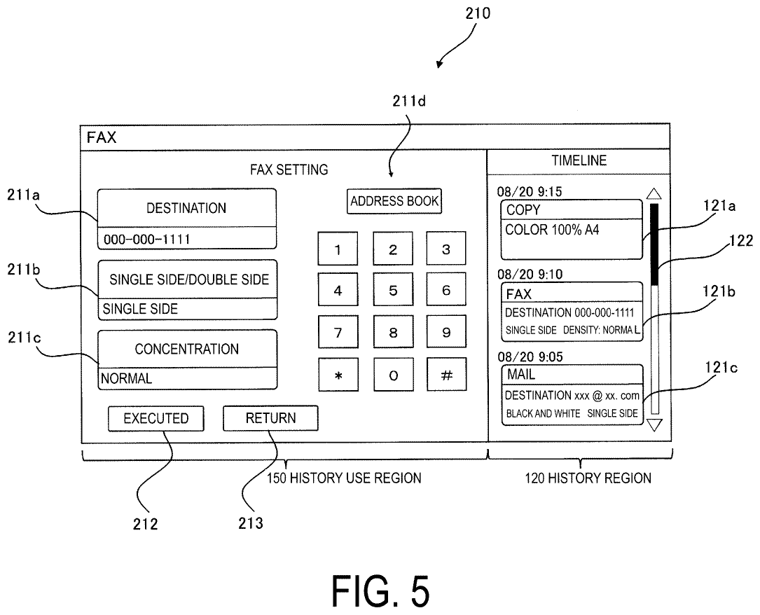

When the operator 41b receives an operation on any of the individual history buttons 121 in the history region 120, the controller 50 controls the display 41a to switch to the history use screen 210 for using the history information corresponding to the individual history button 121. FIG. 5 is a diagram illustrating an example of screen display provided when the history region 120 (history button) according to the embodiment is operated. In the example of FIG. 5, the individual history button 121b related to FAX executed in the past is assumed to be operated.

The history use screen 210 is a screen for setting conditions to be currently applied using, as initial values, the conditions (setting contents) for the past image processing corresponding to the operated history button. With the history use screen 210, the user can use the past setting contents to smoothly and quickly set the setting contents to be currently applied. Such a display operation for the history use screen 210 is a common display operation performed when the history region 120 is used. In the example of FIG. 5, the history use screen 210 uses a region corresponding to the menu region 110 on the home screen 100 as the history use region 150 while maintaining the history region 120.

The history use region 150 includes, for example, a plurality of setting buttons 211 (211a, 211b, . . . ) for setting the setting contents (here, FAX conditions), an execution button 212 for instructing execution of FAX, and a return button 213 for returning to the home screen 100. The setting button 211 displays information indicating the type of the setting item corresponding to the setting button 211. The setting button 211 may display information indicating a setting state of the item corresponding to the setting button 211. In the illustrated example, the type of the setting item is illustrated in the upper portion of the setting button 211, and the current setting state of the item is illustrated in the lower portion of the setting button 211. The number and types of the setting buttons 211 are arbitrary. Here, the setting buttons 211 include a destination button 211a, a single side/double side button 211b, a density button 211c, and a destination designation button group 211d. Since these are common buttons, description thereof will be omitted. The destination button 211a, the single side/double side button 211b, and the density button 211c display conditions for the FAX executed in the past as initial values. When these initial values are used without change, by operating (tapping) the execution button 212, the user can smoothly and quickly realize FAX under the same conditions as the conditions for the FAX executed in the past.

When the conditions are partially changed with respect to the initial values, the user operates the corresponding setting button 211 to partially change the conditions. Then, when the execution button 212 is tapped, the controller 50 controls the image processor 3 to execute FAX under the partially changed conditions. When the button for returning to the home screen 100 is tapped or a certain time elapses, the controller 50 controls the display 41a to switch to the home screen 100. The layout of the various portions described above is arbitrary, and FIG. 5 is merely an example.

Note that when the individual history button 121 is selected on the home screen 100 to transition to the history use screen 210 (immediately after the transition), initial settings of various setting items may be set as appropriate. For example, for the image processing of the same type as the type of the image processing corresponding to the individual history button 121, the settings used when the image processing corresponding to the individual history button 121 was performed may be used as the initial settings. Also for the other types of image processing, the settings used when the image processing corresponding to the individual history button 121 was performed may be used as the initial settings for items common or similar to those of the image processing of the type corresponding to the individual history button 121. Settable items (for example, processing conditions) vary depending on the type of image processing, and thus the number and types of setting buttons 211 (in other words, setting items) displayed on the history use screen 210 may vary.

### Group History Button

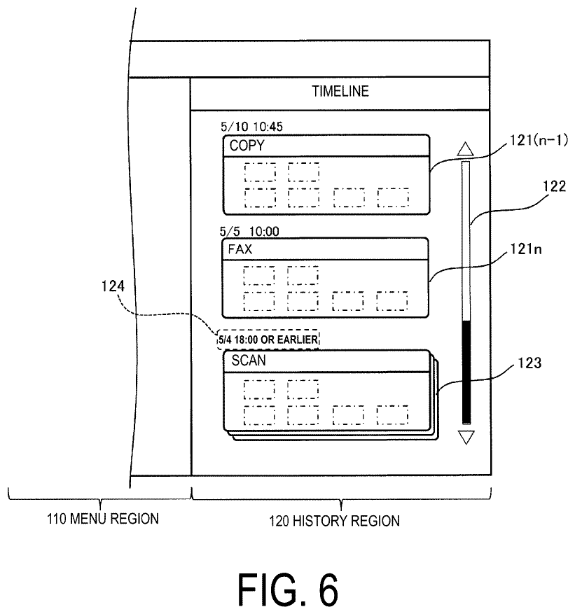

FIG. 6 is a diagram for illustrating a group history button 123 according to the embodiment. In the following description of the drawings, the content displayed by each button may be simplified or omitted.

As illustrated in FIG. 6, in the history region 120, a group history button 123 displaying a group obtained by classifying completed image processing according to a classification condition is arranged in juxtaposition with the individual history button 121. Unlike the individual history button 121, associated with the completed image processing on a one-to-one basis, the group history button 123 is associated with a group including a plurality of completed image processing operations that meet the same classification condition. As a result, a plurality of completed image processing operations can be associated with one history button, and a plurality of completed image processing operations can be designated by an operation on one history button.

In the embodiment, the classification condition is the processing date and time of the image processing. That is, the group history button 123 is associated with a plurality of completed image processing operations classified according to the processing date and time of the image process. In other words, the group history button 123 is associated with a plurality of completed image processing operations performed within a predetermined period in the past. Thus, operating one history button enables designation of a plurality of completed image processing operations performed within a predetermined period of time in the past.

The design of the outer peripheral portion of the group history button 123 is different from the design of the outer peripheral portion of the individual history button 121. In the example of FIG. 6, the group history button 123 has a design in which a plurality of buttons are superimposed. Thus, the user can easily distinguish the group history button 123 from the individual history button 121 based on the design of the outer peripheral portion of the group history button 123. The group history button 123 may be different from the individual history button 121 at least in the design of the outer peripheral portion. Therefore, the overall design of the group history button 123 may be different from the design of the outer peripheral portion of the individual history button 121. For example, the color of the group history button 123 may be different from the color of the individual history button 121.

The information related to the image processing displayed by the group history button 123 may be the same as, and/or similar to, the information displayed by the individual history button 121. The group history button 123 may display information (for example, date and time, type, setting contents, and username) related to one of a plurality of completed image processing operations belonging to the group. For example, in the group history button 123, the setting contents of the one completed image processing operation is displayed.

The display 41a displays, in the history region 120, classification information 124 that is information indicating the classification condition and is associated with the group history button 123. Thus, the user can grasp the group indicated by the group history button 123 based on the displayed classification information 124. In the example of FIG. 6, the classification information 124 is arranged around the group history button 123, specifically, above and along the group history button 123. By arranging the classification information 124 around the group history button 123 rather than inside the group history button 123, the group history button 123 itself can be simply displayed. However, the classification information 124 may be arranged inside the group history button 123.

As described above, in the history region 120, the plurality of individual history buttons 121 are arranged in juxtaposition in chronological order of occurrence of image processing. In an initial state in which a predetermined number (for example, three) of individual history buttons 121 including the latest individual history button 121a are displayed in the history region 120, the display 41a displays, in the history region 120, the predetermined number of individual history buttons 121 including the oldest individual history button 121n, in response to the operator 41b receiving a predetermined operation (for example, a downward scroll operation) on the history region 120. In the embodiment, the group history button 123 is arranged in juxtaposition with the oldest individual history button 121n. That is, when the classification condition is the processing date and time of the image processing, the group history button 123 is arranged at the end of the plurality of individual history buttons 121. When the upper limit value for the individual history buttons 121 that can be displayed in the history region 120 is n (for example, 10), the group history button 123 may be arranged at the n-th position or may be arranged at the (n+1)-th position.

As described above, in the history region 120, the individual history buttons 121 for up to the latest n jobs of the completed image processing jobs can be displayed by scrolling. The group history button 123 is associated with a plurality of completed image processing jobs older than the latest n jobs. In the example of FIG. 6, the oldest completed image processing among the latest n jobs is “FAX” executed at “5/5 10:00”. A plurality of completed image processing jobs older than the latest n jobs are collected in the group history button 123. Specifically, the classification condition corresponding to the group history button 123 is “5/4 18:00 or earlier”, and each completed image processing job executed at “5/4 18:00 or earlier” is associated with the group history button 123.

When the operator 41b receives an operation (for example, a tap) of selecting the group history button 123, the display 41a displays, in an expanded manner, the individual history buttons 126 each for a respective one of the completed image processing operations associated with the selected group history button 123.

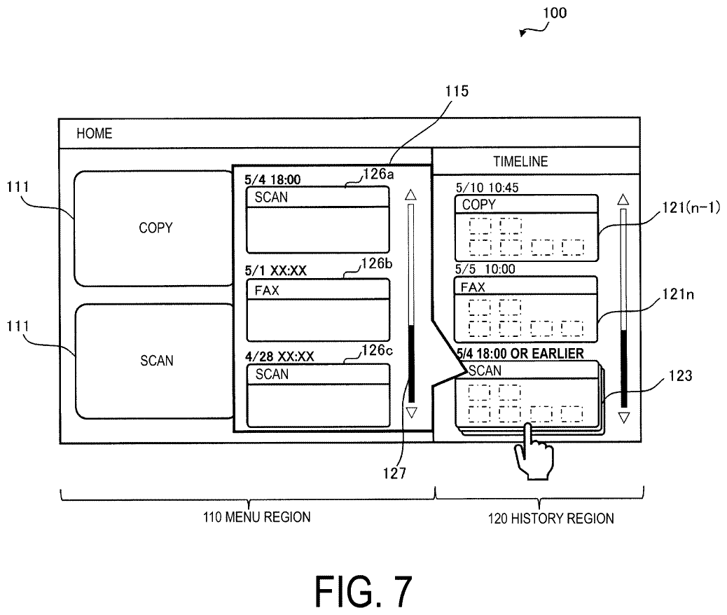

FIG. 7 is a diagram illustrating an example of screen display provided when the group history button 123 according to the embodiment is tapped. In this display example, the individual history buttons 126 displayed in an expanded manner are arranged in such a manner as to be superimposed on the plurality of function buttons 111 in the menu region 110. For example, when the group history button 123 is tapped, the display 41a displays a pop-up region 115 on the menu region 110. The size of the pop-up region 115 is smaller than the size of the menu region 110. Such a pop-up display allows the user to smoothly operate the individual history buttons 126 displayed in an expanded manner.

In the pop-up region 115, the individual history buttons 126 of the completed image processing operations associated with the group history button 123 are arranged. The plurality of individual history buttons 126 (126a, 126b, . . . ) are arranged in a line in a predetermined direction in the order of the date and time when the image processing corresponding to the individual history button 126 was executed (that is, in chronological order). The plurality of individual history buttons 126 may be arranged in any direction. The plurality of individual history buttons 126 may be arranged from one side to the other side in the arrangement direction (from the upper side to the lower side in the illustrated example) in reverse chronological order (in the illustrated example) or in chronological order, or may be switched between reverse chronological order and chronological order by performing a predetermined operation on the operation panel 40. In the description of the present embodiment, the individual history buttons 126 in the pop-up region 115 are arranged in reverse chronological order similarly to the history buttons in the history region 120. To be specific, the latest individual history button 126a is arranged on the uppermost side, and the oldest individual history button 126n is arranged on the lowermost side. The pop-up region 115 may be scrollable by a scroll bar 127. Although an example in which the scroll direction is the vertical direction is illustrated, the scroll direction may be the horizontal direction. The maximum number of individual history buttons 126 that can be displayed by scrolling in the pop-up region 115 may be determined in advance.

The operation performed when the individual history button 126 arranged in the pop-up region 115 is tapped is the same as and/or similar to the operation performed when the individual history button 121 arranged in the history region 120 is tapped. That is, when the operator 41b receives a tap on any of the individual history buttons 126 in the pop-up region 115, the display 41a switches to the history use screen 210 for using the history information corresponding to the individual history button 126.

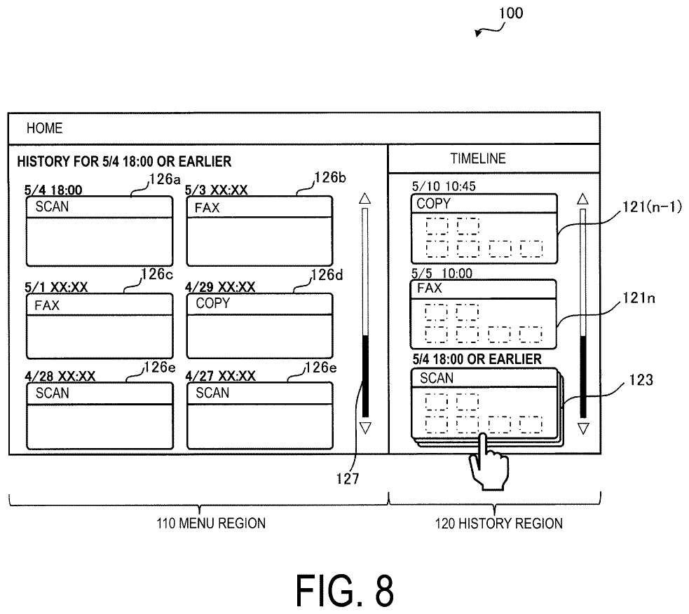

FIG. 8 is a diagram illustrating another example of screen display provided when the group history button 123 according to the embodiment is tapped. In this display example, the individual history buttons 126 displayed in an expanded manner are arranged instead of the plurality of function buttons 111 in the menu region 110. For example, when the group history button 123 is tapped, the display 41a arranges (arrays), in the menu region 110, the individual history buttons 126 of the completed image processing operations associated with the group history button 123. When, in the menu region 110, the individual history buttons 126 displayed in an expanded manner are arranged instead of the plurality of function buttons 111, more individual history buttons 126 can be displayed at a time.

Here, an example is illustrated in which the individual history buttons 126 are arranged in two rows. However, the individual history buttons 126 may be arranged in one row or three rows according to the size of the individual history buttons 126 or the size of the menu region 110. The menu region 110 in this case may be scrollable by the scroll bar 127. Although an example in which the scroll direction is the vertical direction is illustrated, the scroll direction may be the horizontal direction.

The operation performed when the individual history button 126 arranged in the menu region 110 is tapped is the same as and/or similar to the operation performed when the individual history button 121 arranged in the history region 120 is tapped. That is, when the operator 41b receives a tap on any of the individual history buttons 126 in the menu region 110, the display 41a switches to the history use screen 210 for using the history information corresponding to the individual history button 126.

In the above-described display example, the individual history buttons 126 displayed in an expanded manner are arranged in the menu region 110. However, the individual history buttons 126 displayed in an expanded manner may be arranged in the history region 120. In this case, following the plurality of individual history buttons 121, the plurality of individual history buttons 126 are arranged in the history region 120 in chronological order. When the individual history buttons 126 displayed in an expanded manner are arranged in the history region 120, the user can easily recognize that the individual history buttons 126 correspond to a history.

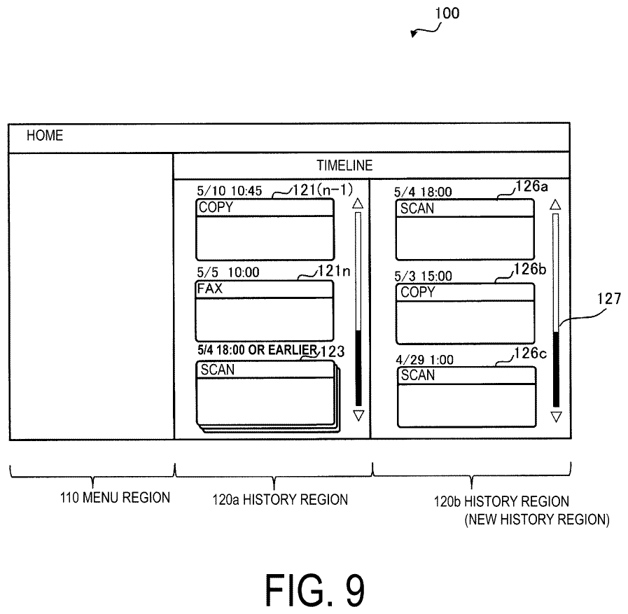

FIG. 9 is a diagram illustrating another example of screen display provided when the group history button 123 according to the embodiment is tapped. In this display example, the individual history buttons 126 displayed in an expanded manner are arranged in a new history region 120b provided separately from the original history region 120a in which the group history button 123 is arranged. Here, the new history region 120b is displayed in juxtaposition with the history region 120a. Displaying the new history region 120b in juxtaposition with the original history region 120a allows to reduce the amount of movement of the user's line of sight and the amount of movement of the user's finger from the original history region 120a to the new history region 120b.

For example, when the group history button 123 is tapped, the display 41a moves, to the left side, the original history region 120a where the group history button 123 is arranged, and arranges the new history region 120b at the position where the original history region 120a was arranged. Then, the display 41a arranges (arrays), in the new history region 120b, the individual history buttons 126 of the completed image processing operations associated with the group history button 123. However, the positional relationship between the original history region 120a and the new history region 120b may be reversed.

Here, an example is illustrated in which the individual history buttons 126 are arranged in one row in the new history region 120b. However, the individual history buttons 126 may be arranged in two or more rows according to the size of the individual history buttons 126 and the size of the menu region 110. The new history region 120b may be scrollable by the scroll bar 127. Although an example in which the scroll direction is the vertical direction is illustrated, the scroll direction may be the horizontal direction.

The operation performed when the individual history button 126 arranged in the new history region 120b is tapped is the same as and/or similar to the operation performed when the individual history button 121 arranged in the history region 120 is tapped. That is, when the operator 41b receives a tap on any of the individual history buttons 126 in the new history region 120b, the display 41a switches to the history use screen 210 for using the history information corresponding to the individual history button 126.

### Control Flow for Image Processing Apparatus

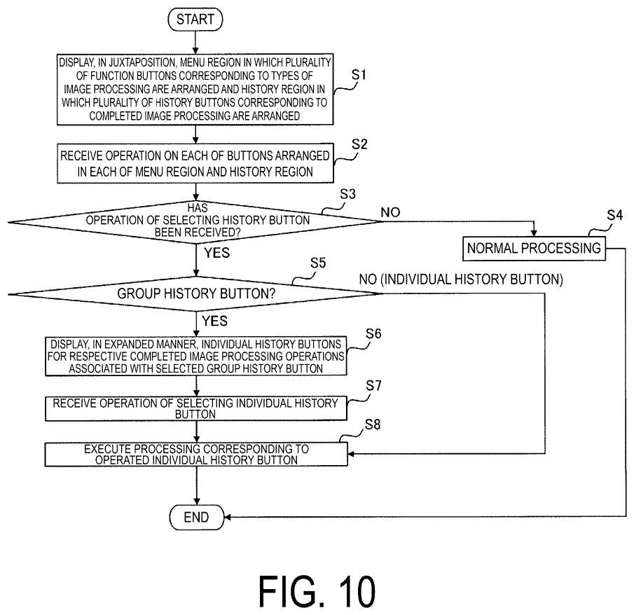

FIG. 10 is a diagram illustrating a control flow for the image processing apparatus 1 according to the embodiment.

In step S1, the controller 50 controls the display 41a to display, in juxtaposition, the menu region 110 in which the plurality of function buttons 111 corresponding to the types of image processing are arranged and the history region 120 in which the plurality of history buttons corresponding to the completed image processing operations are arranged.

In step S2, the operator 41b receives an operation (for example, a tap) on each of the buttons arranged in each of the menu region 110 and the history region 120.

When the operator 41b receives an operation on a button other than the history buttons (the individual history buttons 121 or the group history button 123) arranged in the history region 120 (step S3: NO), the controller 50 executes normal processing (that is, general processing) corresponding to the operated button.

When the operator 41b receives an operation of selecting the individual history button 121 (step S5: NO), the controller 50 executes processing corresponding to the selected individual history button 121 in step S8. To be specific, the controller 50 controls the display 41a to switch to the history use screen 210 for using the history information corresponding to the selected individual history button 121.

When the operator 41b receives the operation of selecting the group history button 123 (step S5: YES), in step S6, the controller 50 controls the display 41a to expand and display the individual history buttons 126 of the completed image processing operations associated with the selected group history button 123. In step S7, the operator 41b receives an operation of selecting any one of the individual history buttons 126 displayed in an expanded manner. In step S8, the controller 50 executes a process corresponding to the selected individual history button 126. To be specific, the controller 50 controls the display 41a to switch to the history use screen 210 for using the history information corresponding to the selected individual history button 126.

### Gist of Embodiments

In the operation panel 40 of the image processing apparatus 1 according to the embodiment, the display 41a displays, in juxtaposition, the menu region 110 in which the plurality of function buttons 111 corresponding to types of image processing are arranged and the history region 120 in which the plurality of history buttons corresponding to completed image processing are arranged. The operator 41b receives an operation on each of the buttons arranged in each of the menu region 110 and the history region 120. In the history region 120, the individual history buttons 121 individually displaying information on completed image processing for each image processing operation are arranged in juxtaposition with the group history button 123 displaying a group obtained by classifying the completed image processing operations according to a classification condition. The display 41a displays, in the history region 120, the classification information 124 that is information indicating the classification condition and that is associated with the group history button 123. As a result, convenience for the user who uses the history button can be further enhanced.

### First Variation Related to Group History Button

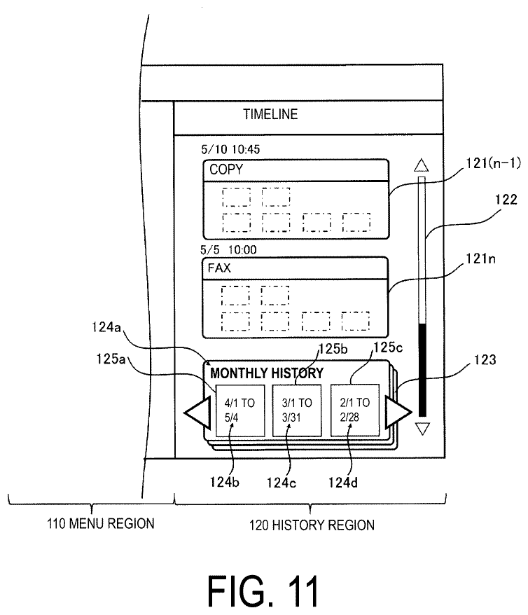

FIG. 11 is a diagram for describing the group history buttons 123 according to the present variation.

In the present variation, the group history button 123 is associated with each of the completed image processing operations classified according to a first classification condition. The display 41a displays, in the group history button 123, subgroup history buttons 125 (125a, 125b, and 125c) each indicating a subgroup into which the completed image processing operations associated with the group history button 123 are classified according to a second classification condition.

In the illustrated example, the first classification condition is the processing date and time of the image processing, specifically, a monthly history. The display 41a displays the classification information 124a indicating the first classification condition, inside the group history button 123 and outside the subgroup history buttons 125. The second classification condition is a condition more detailed than the first classification condition, specifically, “4/1 to 5/4”, “3/1 to 3/31”, and “2/1 to 2/28”. The display 41a displays, inside the subgroup history buttons 125a, 125a, and 125c, classification information 124b, 124c, and 124d indicating the second classification condition.

Performing a left or right flick operation on the group history button 123 allows to change the option for the period, that is, the subgroup history button 125 to be displayed. The group history button 123 is provided with triangular symbol images indicating that a left or right flick operation is enabled. Left or right scrolling may be enabled by touching the symbol image. In the illustrated example, a right flick or scroll operation on the group history button 123 causes the subgroup history button 125 corresponding to an earlier period to be displayed in the group history button 123. Note that, in the illustrated example, three subgroup history buttons 125 are displayed at one time in the group history button 123 but that one or two subgroup history buttons 125 or four or more subgroup history buttons may be displayed at one time in the group history button 123.

When the operator 41b receives an operation (for example, a tap) of selecting one of the subgroup history buttons 125, the display 41a displays, in an expanded manner, the individual history buttons 126 each for a respective one of the completed image processing operations associated with the selected subgroup history button 125. A method of displaying the individual history buttons 126 in an expanded manner is the same as, and/or similar to, that in the above-described embodiment.

According to the present variation, since the subgroup history buttons 125 (125a, 125a, and 125c) are displayed in the group history button 123, the individual history buttons 126 displayed in an expanded manner can be narrowed down by selecting the subgroup history buttons 125. Accordingly, the convenience for the user who uses the history button can be further enhanced.

### Second Variation Related to Group History Button

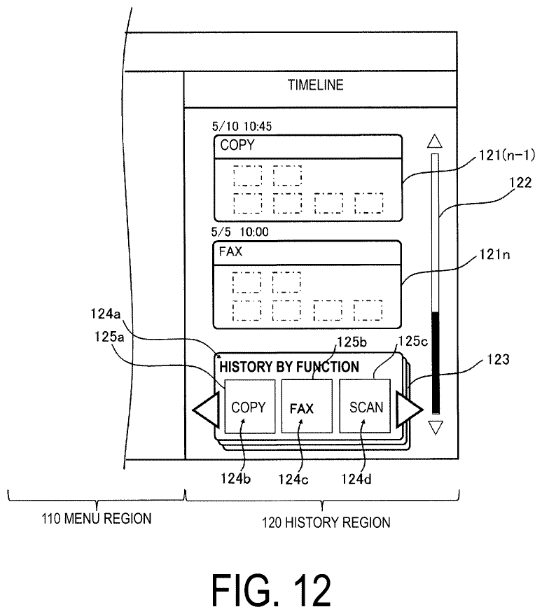

FIG. 12 is a diagram for describing the group history button 123 according to the present variation.

In the present variation, the classification condition is the type of image processing. That is, the group history button 123 is associated with a plurality of completed image processing operations classified according to the type of image processing. In other words, the group history button 123 is associated with completed image processing operations for each function of the image processing apparatus 1. As a result, an operation on the history button enables a plurality of past completed image processing operations to be designated for each function.

In the illustrated example, the group history button 123 is associated with each of the completed image processing operations classified according to the first classification condition. The display 41a displays, in the group history button 123, subgroup history buttons 125 (125a, 125a, and 125c) each indicating a subgroup into which the completed image processing operations associated with the group history button 123 are classified according to a second classification condition.

Here, the first classification condition is a type of image processing, specifically, a history for each function. The display 41a displays the classification information 124a indicating the first classification condition, inside the group history button 123 and outside the subgroup history buttons 125. The second classification condition is a more detailed condition than the first classification condition, and specifically includes “copy”, “FAX”, and “scan”. The display 41a displays, inside the subgroup history buttons 125a, 125a, and 125c, classification information 124b, 124c, and 124d indicating the second classification condition.

A left or right flick operation on the group history button 123 enables change of the option for the type of image processing, that is, the subgroup history button 125 to be displayed. The group history button 123 is provided with triangular symbol images indicating that a left or right flick operation is enabled. Left or right scrolling may be enabled by touching the symbol image. In the illustrated example, a right flick or scroll operation on the group history button 123 causes the subgroup history button 125 corresponding to another function (e.g., mail, box save, etc.) to be displayed within the group history button 123. Note that, in the illustrated example, three subgroup history buttons 125 are displayed at one time in the group history button 123 but that one or two subgroup history buttons 125 or four or more subgroup history buttons may be displayed at one time in the group history button 123.

When the operator 41b receives an operation (for example, a tap) of selecting one of the subgroup history buttons 125, the display 41a displays, in an expanded manner, the individual history buttons 126 each for a respective one of the completed image processing operations associated with the selected subgroup history button 125. A method of displaying the individual history buttons 126 in an expanded manner is the same as, and/or similar to, that in the above-described embodiment.

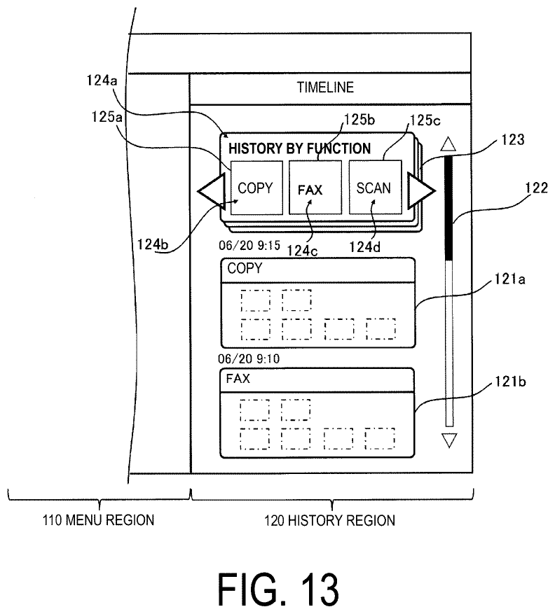

In FIG. 12, the group history button 123 is arranged at the end position in the chronological order in the history region 120. In this case, in order to display the group history button 123, a downward scroll operation may need to be performed on the history region 120. Therefore, in the present variation, as illustrated in FIG. 13, the group history button 123 may be arranged at the top position in the chronological order in the history region 120. That is, when the classification condition is the type of image processing, the group history button 123 may be arranged in juxtaposition with the latest individual history button 121a. This allows the user to more easily select the group history button 123.

According to the present variation, the group history button 123 can be associated with the completed image processing for each function, and thus the user can easily designate the completed image processing for the desired function.

### Third Variation Related to Group History Button

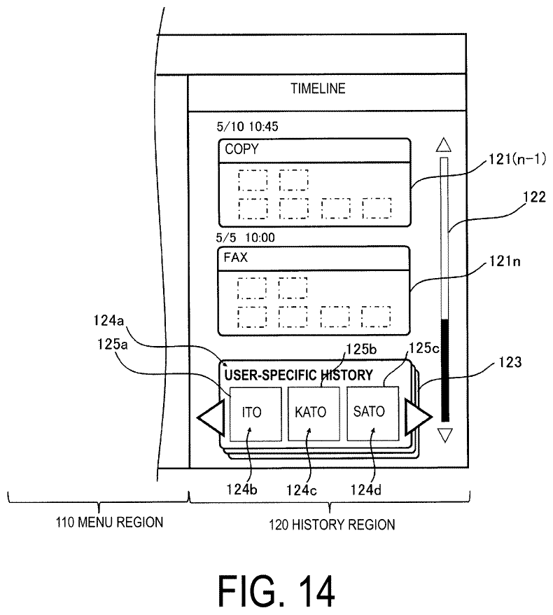

FIG. 14 is a diagram for describing the group history button 123 according to the present variation.

In the present variation, the classification condition is a username corresponding to image processing. That is, the group history button 123 is associated with a plurality of completed image processing operations classified according to the username corresponding to the image processing. In other words, the group history button 123 is associated with the completed image processing for each user in the image processing apparatus 1. Thus, an operation on the history button enables a plurality of past completed image processing operations to be designated for each user who has performed the image processing.

In the illustrated example, the group history button 123 is associated with each of the completed image processing operations classified according to the first classification condition. The display 41a displays, in the group history button 123, subgroup history buttons 125 (125a, 125a, and 125c) each indicating a subgroup into which the completed image processing operations associated with the group history button 123 are classified according to a second classification condition.

Here, the first classification condition is the username corresponding to the image processing, specifically, a history for each user. The display 41a displays the classification information 124a indicating the first classification condition, inside the group history button 123 and outside the subgroup history buttons 125. The second classification condition is more detailed than the first classification condition, and specifically includes “Ito”, “Kato”, and “Sato”. The display 41a displays, inside the subgroup history buttons 125a, 125a, and 125c, classification information 124b, 124c, and 124d indicating the second classification condition.

The option for the username, that is, the subgroup history button 125 to be displayed can be changed by a flick operation on the group history button 123 to the left or right. The group history button 123 is provided with triangular symbol images indicating that a left or right flick operation is enabled. Left or right scrolling may be enabled by touching the symbol image. In the illustrated example, a right flick or scroll operation on the group history button 123 causes the subgroup history button 125 corresponding to another user to be displayed in the group history button 123. Note that, in the illustrated example, three subgroup history buttons 125 are displayed at one time in the group history button 123 but that one or two subgroup history buttons 125 or four or more subgroup history buttons may be displayed at one time in the group history button 123.

When the operator 41b receives an operation (for example, a tap) of selecting one of the subgroup history buttons 125, the display 41a displays, in an expanded manner, the individual history buttons 126 each for a respective one of the completed image processing operations associated with the selected subgroup history button 125. A method of displaying the individual history buttons 126 in an expanded manner is the same as, and/or similar to, that in the above-described embodiment.

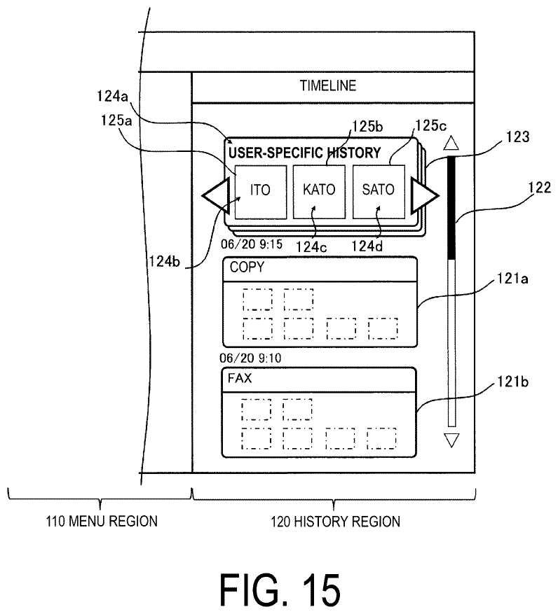

In FIG. 14, the group history button 123 is arranged at the end of the chronological order in the history region 120. In this case, in order to display the group history button 123, a downward scroll operation may need to be performed on the history region 120. Accordingly, in the present variation, as illustrated in FIG. 15, the group history button 123 may be arranged at the top position in the chronological order in the history region 120. That is, when the classification condition is the username, the group history button 123 may be arranged in juxtaposition with the latest individual history button 121a. This allows the user to more easily select the group history button 123.

According to the present variation, since the group history button 123 can be associated with the completed image processing for each user, the completed image processing for the desired user is easily designated.

Note that, in the present variation, a user who operates the image processing apparatus 1 is assumed to be identifiable by user authentication or the like. When the subgroup history button 125 for a certain user is selected, the display 41a may display an object for prompting input of authentication information (for example, an ID and a password) of the user. The display 41a may perform the expanded display only when such user authentication is successful.

### Fourth Variation Related to Group History Button

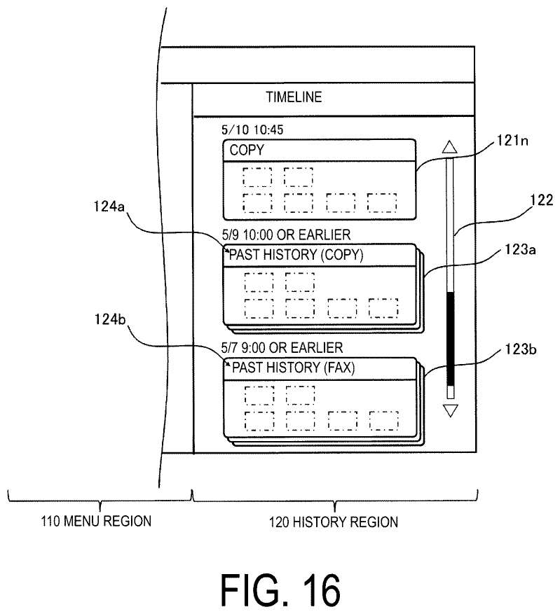

FIG. 16 is a diagram for describing the group history button 123 according to the present variation.

In the present variation, the display 41a displays, in the history region 120, a plurality of group history buttons 123 obtained by classifying the completed image processing operations according to classification conditions different from each other. In the illustrated example, two group history buttons 123a and 123b are displayed, but three or more group history buttons 123 may be displayed in the history region 120. The display 41a displays the classification information 124 (124a and 124b) indicating the corresponding classification condition for each of the plurality of group history buttons 123 (123a and 123b).

In the illustrated example, the classification condition for the group history button 123a is the past history (copy), to be specific, the history of copies before 5/9 10:00. That is, the group history button 123a is associated with the copies before 5/9 10:00. On the other hand, the classification condition for the group history button 123b is the past history (FAX), to be specific, the history of FAX before 5/7 9:00. That is, the group history button 123b is associated with the FAXes before 5/7 9:00.

When the operator 41b receives an operation (for example, a tap) of selecting one of the group history buttons 123, the display 41a displays, in an expanded manner, the individual history buttons 126 each for a respective one of the completed image processing operations associated with the selected group history button 123. A method of displaying the individual history buttons 126 in an expanded manner is the same as, and/or similar to, that in the above-described embodiment.

According to the present variation, by associating different classification conditions with the respective group history buttons 123, the user can select the group history button 123 corresponding to the desired classification condition, thus further improving the convenience for the user.

### Fifth Variation Related to Group History Button

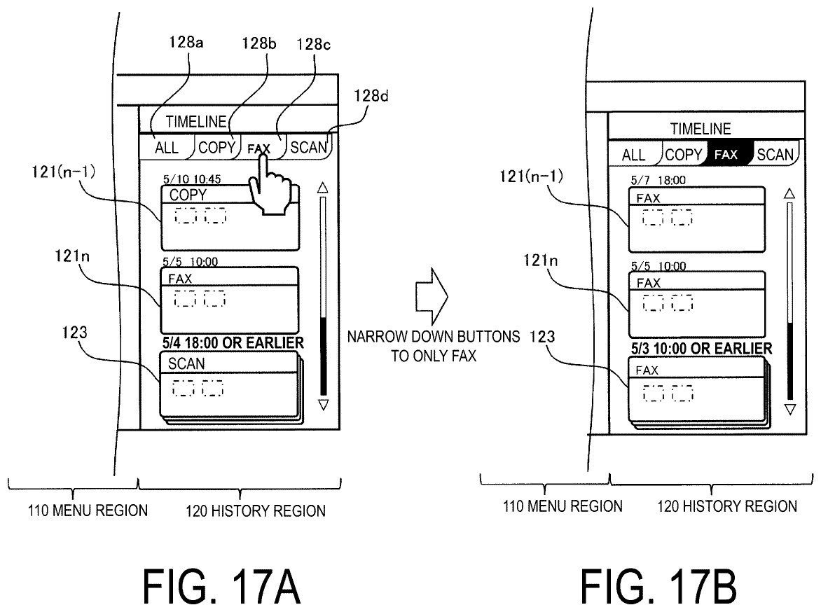

FIGS. 17A and 17B are diagrams for describing the group history button 123 according to the present variation.

In the present variation, as illustrated in FIG. 17A, the operator 41b receives, from the user, an operation of designating an extraction condition of extracting the completed image processing whose information is displayed in the history region 120. In the illustrated example, buttons 128 (128a to 128d) for designating the type of image processing as an extraction condition are arranged in the upper portion of the history region 120. Alternatively, buttons 128 (128a to 128d) for designating a username as an extraction condition may be arranged in the upper portion of the history region 120.

Note that the classification condition for the group history button 123 is the date and time of image processing, specifically, “5/4 18:00 or earlier”. That is, the completed image processing operations for “5/4 18:00 or earlier” are associated with the group history button 123.

In the illustrated example, the button 128a is for selecting “all” as the type of image processing, the button 128b is for selecting “copy” as the type of image processing, the button 128c is for selecting “FAX” as the type of image processing, and the button 128d is for selecting “scan” as the type of image processing. In this regard, the following description will be given on the assumption that the button 128c (FAX) id tapped.

As illustrated in FIG. 17B, the display 41a displays the individual history buttons 121 each associated with a respective one of the completed image processing operations that meet the designated extraction condition (here, “FAX”) in the history region 120. The group history button 123 is associated with each of the completed image completed image processing operations that meet both the classification condition and the extraction condition for the group history button 123. Specifically, the controller 50 associates only “FAX” among the completed image processing operations for “5/4 18:00 or earlier” with the group history button 123. In this way, when the individual history buttons 121 are narrowed down by the type of image processing, the group history buttons 123 are also simultaneously narrowed down by the type of image processing.

When the operator 41b receives an operation (for example, a tap) of selecting the group history button 123, the display 41a displays, in an expanded manner, the individual history buttons 126 each for a respective one of the completed image processing operations associated with the selected group history button 123. To be specific, the display 41a displays, in an expanded manner, the individual history buttons 126 for “FAX” and “5/4 18:00 or earlier”. The method for expanded display is the same as, and/or similar to, that of the embodiment described above.

According to the present variation, when the individual history buttons 121 are narrowed down by the type of image processing, the group history button 123 can also simultaneously be narrowed down by the type of image processing. Accordingly, the convenience for the user who uses the history button can be further enhanced.

### Sixth Variation Related to Group History Button

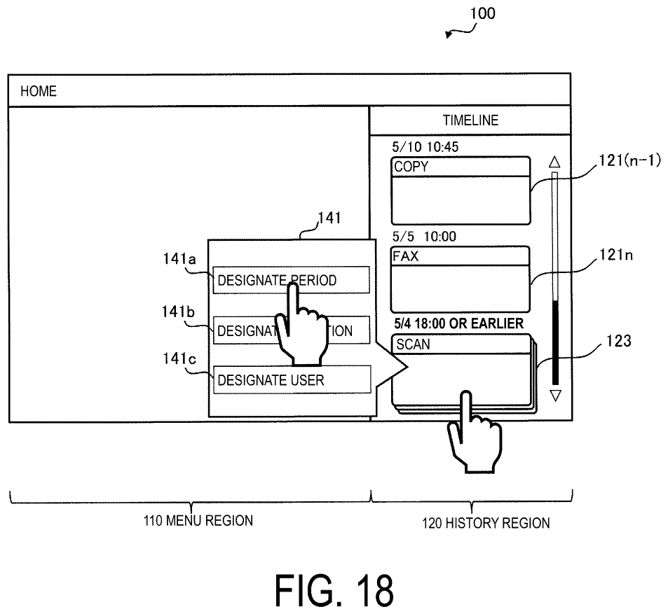

FIGS. 18 to 20 are diagrams for describing the group history button 123 according to the present variation.

First, as illustrated in FIG. 18, the operator 41b receives, from the user, an operation of designating a narrowing-down condition of narrowing down the individual history buttons 126 displayed in an expanded manner. For example, when the operator 41b receives a holding-down operation on the group history button 123, the display 41a displays a pop-up region 141 for designating a narrowing-down condition. In the pop-up region 141, a button 141a for selecting the processing date and time (period), a button 141b for selecting the type (function) of image processing, and a button 141c for selecting the user (username) are arranged as the narrowing-down conditions. In this regard, the following description will be given on the assumption that the button 141a is tapped. However, in the pop-up region 141, two or more buttons 141 (that is, two or more conditions) may be selectable.

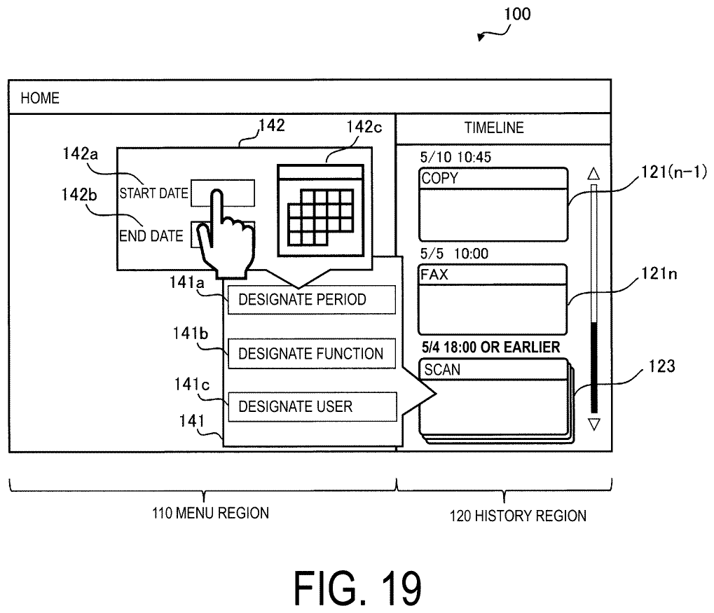

Then, as illustrated in FIG. 19, the display 41a displays a pop-up region 142 for designating the processing date and time (period). Objects 142a to 142c for designating a start date and an end date are arranged in the pop-up region 142. The operator 41b receives an operation of designating the processing date and time (period) for the objects 142a to 142c. In the following description, “2022/01/01 to 01/31” is assumed to be designated as the narrowing-down condition.

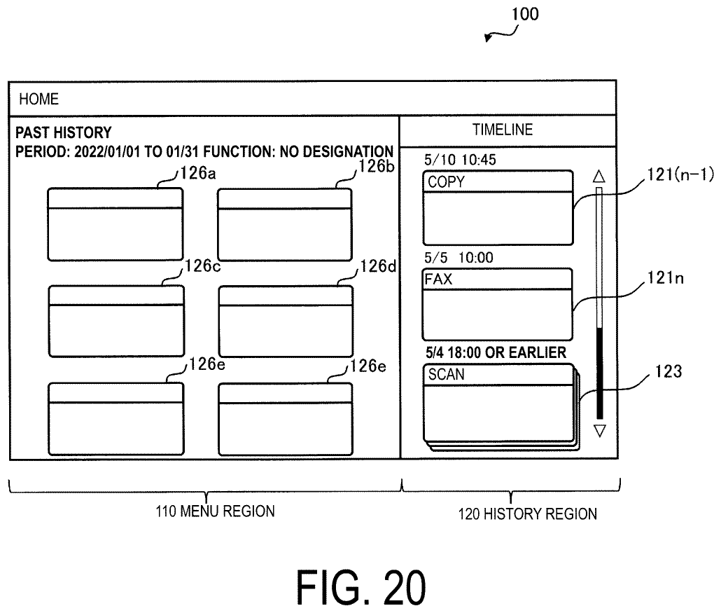

Then, as illustrated in FIG. 20, the display 41a displays, in an expanded manner, the individual history buttons 126 for the respective completed image processing operations that meet the designated narrowing-down condition among the completed image processing operations associated with the group history button 123. The method for expanded display is the same as, and/or similar to, that of the above-described embodiment. However, in the illustrated example, the individual history buttons 126 are arranged instead of the function buttons 111 in the menu region 110.

According to the present variation, since the individual history buttons 126 displayed in an expanded manner can be narrowed down, the convenience for the user who uses the history buttons can be further enhanced.

### Other Embodiments

In the above-described embodiment and variations thereof, the operator 41b may receive, from the user, a setting operation of designating a classification condition for the group history button 123. The controller 50 may set a group according to the setting operation. For example, the controller 50 may associate each of the completed image processing operations classified according to the processing date and time with the group history button 123 in response to the operator 41b receiving, from the user, a setting operation of designating the processing date and time as the classification condition. Alternatively, the controller 50 may associate each of the completed image processing operations classified according to the type of image processing with the group history button 123 in response to the operator 41b receiving, from the user, a setting operation of designating the type of image processing as the classification condition. Alternatively, the controller 50 may associate each of the completed image processing operations classified according to the username with the group history button 123 in response to the operator 41b receiving, from the user, a setting operation of designating the username as the classification condition.

The operational flow of the embodiment described above need not necessarily be executed in chronological order according to the order described in the flow diagram. For example, the steps of operation may be performed in a different order from that described in the flow diagram or may be performed in parallel. Some steps of operation may be omitted and additional steps may be added to the process.

A program may be provided that causes the image processing apparatus 1 to perform operations according to the embodiment described above. The program may be recorded on a computer readable medium. Use of the computer readable medium enables the program to be installed on the computer (image processing apparatus 1). Here, the computer readable medium on which the program is recorded may be a non-transitory recording medium. The non-transitory recording medium is not particularly limited, and may be, for example, a recording medium such as a CD-ROM or a DVD-ROM. Circuits for executing processing operations performed by the image processing apparatus 1 may be integrated, and at least part of the image processing apparatus 1 may be configured as a semiconductor integrated circuit (a chipset or an SoC).

The phrases “based on” and “depending on” used in the present disclosure do not mean “based only on” and “depending only on,” unless specifically stated otherwise. The phrase “based on” means both “based only on” and “based at least in part on”. The phrase “depending on” means both “only depending on” and “at least partially depending on”. The terms “include”, “comprise”, and variations thereof do not mean “include only items stated” but instead mean “may include only items stated” or “may include not only the items stated but also other items”. The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a,” “an,” and “the” are added in the present disclosure through translation, these articles include the plural unless clearly indicated otherwise in context.

Embodiments have been described above in detail with reference to the drawings, but specific configurations are not limited to those described above, and various design variation can be made without departing from the gist of the present disclosure.

### Supplementary Note

Features relating to the embodiments described above are described below as supplements.

### Supplementary Note 1

An image processing apparatus 1 including:
an operation panel 40 including
a display 41a configured to display, in juxtaposition, a menu region 110 in which a plurality of function buttons 111 each corresponding to a type of image processing operation are arranged and a history region 120 in which a plurality of history buttons each corresponding to a completed image processing operation are arranged, and
an operator 41b configured to receive an operation on each of the plurality of function buttons arranged in the menu region 110 and the plurality of history buttons arranged in the history region 120,
wherein, in the history region 120, an individual history button 121 that displays information on the completed image processing operation individually per image processing operation and a group history button 123 that displays a group obtained by classifying the completed image processing operation according to a classification condition are arranged in juxtaposition, and the display 41a is configured to display, in the history region 120, classification information 124 that is information indicating the classification condition and that is associated with the group history button 123.

### Supplementary Note 2

The image processing apparatus 1 according to Supplementary Note 1, wherein the classification condition is one of a processing date and time of an image processing operation, a type of the image processing operation, and a username corresponding to the image processing operation.

### Supplementary Note 3

The image processing apparatus 1 according to Supplementary Note 1 or 2 wherein the operator 41b is configured to receive a setting operation of designating the classification condition from a user, and
the group is set in accordance with the setting operation.

### Supplementary Note 4

The image processing apparatus 1 according to any one of Supplementary Notes 1 to 3, wherein a design of an outer peripheral portion of the group history button 123 is different from a design of an outer peripheral portion of the individual history button 121.

### Supplementary Note 5

The image processing apparatus 1 according to any one of Supplementary Notes 1 to 4, wherein the classification information 124 is arranged inside the group history button 123 or around the group history button 123.

### Supplementary Note 6

The image processing apparatus 1 according to any one of Supplementary Notes 1 to 5, wherein in the history region 120, a plurality of individual history buttons 121 are arranged in juxtaposition in chronological order of occurrences of image processing operations, and the display 41a is configured to display, in an initial state in which a predetermined number of individual history buttons 121 including a latest individual history button 121a are displayed in the history region 120, a predetermined number of individual history buttons 121 including an oldest individual history button 121n in the history region 120 in response to the operator 41b receiving a predetermined operation on the history region 120, and
the group history button 123 is arranged in juxtaposition with the latest individual history button 121a or the oldest individual history button 121n.

### Supplementary Note 7

The image processing apparatus 1 according to Supplementary Note 6, wherein, when the classification condition is a processing date and time of an image processing operation, the group history button 123 is arranged in juxtaposition with the oldest individual history button 121n.

### Supplementary Note 8

The image processing apparatus 1 according to Supplementary Note 6 or 7, wherein, when the classification condition is a type of an image processing operation or a username corresponding to the image processing operation, the group history button 123 is arranged in juxtaposition with the latest individual history button 121a.

### Supplementary Note 9

The image processing apparatus 1 according to any one of Supplementary Notes 1 to 8, wherein the group history button 123 is associated with each completed image processing operation classified according to a first classification condition, and the display 41a is configured to display, in the group history button 123, a subgroup history button 125 indicating a subgroup into which each completed image processing operation associated with the group history button 123 is classified according to a second classification condition.

### Supplementary Note 10

The image processing apparatus 1 according to any one of Supplementary Notes 1 to 9, wherein, the display 41a is configured to display, when the history region 120 displays a plurality of group history buttons 123 in which completed image processing operations are classified according to classification conditions different from each other, the classification information 124 indicating a corresponding classification condition for each of the plurality of group history buttons 123.

### Supplementary Note 11

The image processing apparatus 1 according to any one of Supplementary Notes 1 to 10, wherein
the operator 41b is configured to receive, from a user, an operation of designating an extraction condition of extracting a completed image processing operation whose information is displayed in the history region 120,
the display 41a is configured to display, in the history region 120, the individual history button 121 associated with each completed image processing operation that meets the extraction condition, and
the group history button 123 is associated with each completed image processing operation that meets both the classification condition and the extraction condition.

### Supplementary Note 12

The image processing apparatus 1 according to any one of Supplementary Notes 1 to 11, wherein the display 41a is configured to display, in response to the operator 41b receiving an operation of selecting the group history button 123, the individual history buttons 126 for respective completed image processing operations associated with the selected group history button 123 in an expanded manner.

### Supplementary Note 13

The image processing apparatus 1 according to Supplementary Note 12, wherein the individual history buttons 126 displayed in the expanded manner are arranged in such a manner as to be superimposed on the plurality of function buttons 111 in the menu region 110.

### Supplementary Note 14

The image processing apparatus 1 according to Supplementary Note 12, wherein the individual history buttons 126 displayed in the expanded manner are arranged instead of the plurality of function buttons 111 in the menu region 110.

### Supplementary Note 15

The image processing apparatus 1 according to Supplementary Note 12, wherein the individual history buttons 126 displayed in the expanded manner are arranged in the history region 120.

### Supplementary Note 16

The image processing apparatus 1 according to Supplementary Note 12, wherein the individual history buttons 126 displayed in the expanded manner are arranged in a new history region 120 provided separately from the history region 120.

### Supplementary Note 17

The image processing apparatus 1 according to Supplementary Note 16, wherein the new history region 120 is displayed in juxtaposition with the history region 120.

### Supplementary Note 18

The image processing apparatus 1 according to any one of Supplementary Notes 12 to 17, wherein
the operator 41b is configured to receive, from a user, an operation of designating a narrowing-down condition of narrowing down the individual history buttons 126 displayed in the expanded manner, and
the display 41a is configured to display, in an expanded manner, the individual history buttons for respective completed image processing operations that meet the designated narrowing-down condition among the completed image processing operations associated with the group history button 123.

### Supplementary Note 19

A control method for controlling an image processing apparatus 1, the control method including:
a step S1 of displaying, in juxtaposition on an operation panel 40, a menu region 110 in which a plurality of function buttons 111 each corresponding to a type of image processing operation are arranged and a history region 120 in which a plurality of history buttons each corresponding to a completed image processing operation are arranged, and
a step S2 of receiving, on the operation panel 40, an operation on each of the plurality of function buttons 111 arranged in the menu region 110 and the plurality of history buttons arranged in the history region 120,
wherein, in the history region 120, an individual history button 121 configured to display information on the completed image processing operation individually per image processing operation and a group history button 123 configured to display a group obtained by classifying the completed image processing operation according to a classification condition are arranged in juxtaposition, and
the step S1 of displaying includes a step of displaying, in the history region 120, classification information 124 that is information indicating the classification condition and that is associated with the group history button 123.

### Supplementary Note 20

A control program causing an image processing apparatus 1 to execute:
a step S1 of displaying, in juxtaposition on an operation panel 40, a menu region 110 in which a plurality of function buttons 111 each corresponding to a type of image processing operation are arranged and a history region 120 in which a plurality of history buttons each corresponding to a completed image processing operation are arranged, and
a step S2 of receiving, on the operation panel 40, an operation on each of the plurality of function buttons 111 arranged in the menu region 110 and the plurality of history buttons arranged in the history region 120,

wherein, in the history region 120, an individual history button 121 configured to display information on the completed image processing operation individually per image processing operation and a group history button 123 configured to display a group obtained by classifying the completed image processing operation according to a classification condition are arranged in juxtaposition, and
the step S1 of displaying includes a step of displaying, in the history region 120, classification information 124 that is information indicating the classification condition and that is associated with the group history button 123.

1. An image processing apparatus comprising:
a display configured to display, in juxtaposition, a main display region in which a plurality of function buttons each corresponding to a type of image processing operation are arranged and a sub-display region in which a plurality of buttons each corresponding to a job of image processing are arranged; and
an operator configured to receive a user's input,
wherein the display is configured to:
display, in the sub-display region, as the plurality of buttons, an individual button that displays job information of image processing operation individually per image processing operation and a group button that displays a group obtained by classifying job information of image processing operation according to a classification condition, in juxtaposition;
display, in the sub-display region, classification information that indicates the classification condition and that is associated with the group button; and
display, in an expanded manner, the job information of the image processing operation associated with the group button selected, in response to an operation of selecting the group button.

2. The image processing apparatus according to claim 1, wherein
the classification condition is one of a processing date and time of an image processing operation, the type of the image processing operation, and a username corresponding to the image processing operation.

3. The image processing apparatus according to claim 1, wherein
the operation panel is configured to receive a setting operation of designating the classification condition from a user, and
the group is set in accordance with the setting operation.

4. The image processing apparatus according to claim 1, wherein
a design of an outer peripheral portion of the group button is different from a design of an outer peripheral portion of the individual button.

5. The image processing apparatus according to claim 1, wherein
the group button is associated with each job of image processing operation classified according to a first classification condition, and
the display is configured to display, in the group button, a subgroup button indicating a subgroup into which each job of image processing operation associated with the group button is classified according to a second classification condition.

6. The image processing apparatus according to claim 1, wherein:
the display is configured to display, when a plurality of group buttons in which jobs of image processing operations are classified according to classification conditions different from each other are displayed in the sub-display region, the classification information indicating a corresponding classification condition for each of the plurality of group buttons.

7. The image processing apparatus according to claim 1, wherein:
the individual buttons displayed in the expanded manner are arranged in such a manner as to be superimposed on the plurality of function buttons in the menu region,
the individual buttons displayed in the expanded manner are arranged instead of the plurality of function buttons in the menu region, or
the individual buttons displayed in the expanded manner are arranged in the sub- display region.

8. The image processing apparatus according to claim 1, wherein:
the operation panel is configured to receive, from a user, an operation of designating a narrowing-down condition of narrowing down the individual buttons displayed in the expanded manner; and
the display is configured to display, in an expanded manner, the individual buttons for respective image processing operations that meet the designated narrowing-down condition among the image processing operations associated with the group button.

9. An image processing apparatus comprising:
a display configured to display, in juxtaposition, a main display region in which a plurality of function buttons each corresponding to a type of image processing operation are arranged and a sub-display region in which a plurality of buttons each corresponding to a job of image processing operation are arranged; and
an operator configured to receive a user's input,
wherein the display is configured to:
display, in the sub-display region, as the plurality of buttons, an individual button that displays job information of image processing operation individually per image processing operation and a group button that displays a group obtained by classifying the job information of image processing operation according to a classification condition, in juxtaposition; and
display, in the sub-display region, classification information that is information indicating the classification condition and that is associated with the group button.

10. The image processing apparatus according to claim 2, wherein
the classification condition is one of a processing date and time of an image processing operation, the type of the image processing operation, and a user name corresponding to the image processing operation.

11. The image processing apparatus according to claim 9, wherein
the operation panel is configured to receive a setting operation of designating the classification condition from a user, and
the group is set in accordance with the setting operation.

12. The image processing apparatus according to claim 9, wherein
a design of an outer peripheral portion of the group button is different from a design of an outer peripheral portion of the individual button.

13. The image processing apparatus according to claim 9, wherein
the group button is associated with each job of image processing operation classified according to a first classification condition, and
the display is configured to display, in the group button, a subgroup button indicating a subgroup into which each job of image processing operation associated with the group button is classified according to a second classification condition.

14. The image processing apparatus according to claim 9, wherein:
the display is configured to display, when a plurality of group buttons in which jobs of image processing operations are classified according to classification conditions different from each other are displayed in the sub-display region, the classification information indicating a corresponding classification condition for each of the plurality of group buttons.

15. The image processing apparatus according to claim 9, wherein:
the display is configured to display, in an expanded manner in the sub-display region, the job information of the image processing operation associated with the group button selected in response to an operation of selecting the group button received by the operation panel.

16. The image processing apparatus according to claim 9, wherein:
the individual buttons displayed in the expanded manner are arranged in such a manner as to be superimposed on the plurality of function buttons in the menu region,
the individual buttons displayed in the expanded manner are arranged instead of the plurality of function buttons in the menu region, or
the individual buttons displayed in the expanded manner are arranged in the sub- display region.

17. The image processing apparatus according to claim 9, wherein:
the operation panel is configured to receive, from a user, an operation of designating a narrowing-down condition of narrowing down the individual buttons displayed in the expanded manner; and
the display is configured to display, in an expanded manner, the individual buttons for respective image processing operations that meet the designated narrowing-down condition among the image processing operations associated with the group button.

18. A control method for controlling an image processing apparatus, the control method comprising:
displaying, in juxtaposition on an operation panel, a main display region in which a plurality of function buttons each corresponding to a type of image processing operation are arranged and a sub-display region in which a plurality of buttons each corresponding to a job of image processing are arranged; and
receiving, on the operation panel, an operation on each of the plurality of function buttons arranged in the main display region and the plurality of buttons arranged in the sub-display region,
wherein the display is configured to:
display, in juxtaposition, in the sub-display region, as the plurality of buttons, an individual button that displays job information of image processing operation individually per image processing operation and a group button that displays a group obtained by classifying the job information of image processing operation according to a classification condition; and
displaying includes displaying, in the sub-display region, classification information that is information indicating the classification condition and that is associated with the group button.
